(19) United States
(12) Patent Application Publication
(10) Pub. No.: US 2004/0034468 A1
(43) Pub. Date: Feb. 19, 2004

(54) Navigation device and system and method for trasmitting facility information

(76) Inventors: Yoshihide Kobayashi, Iwaki-city (JP); Tatsuo Isa, Iwaki-city (JP)

Correspondence Address: BRINKS HOFER GILSON & LIONE, P.O. BOX 10395, CHICAGO, IL, 60611, US

(21) Appl. No.: 10/455,591

(22) Filed: Jun. 5, 2003

(30) Foreign Application Priority Data
Jun. 13, 2002 (JP) 2002-172580

(51) Int. Cl. G01C 21/26

(52) U.S. Cl. 701/205

(57) ABSTRACT

A navigation device including a facility searching unit operable to search for and retrieve a specific facility, a transmission image generator operable to generate a map image of an area around the specific facility, and a transmission processor operable to transmits the category, the name, and the telephone number of the specific facility and the map image of the area around the specific facility to a cellular phone. The cellular phone registers the data transmitted from the navigation device.

### BACKGROUND

1. Field of the Invention

The present invention relates to a navigation device having a function to select a facility in accordance with an operation performed by a user, and also relates to a system and a method for transmitting facility information.

2. Description of the Related Art

Most navigation devices have the ability to display a map of an area around a vehicle, to search for an optimal route to a destination under a plurality of search conditions, to guide the vehicle along the determined route, and to search for a specific facility under a condition specified by the user. When the specific facility is retrieved, the location thereof may be displayed on the map and the specific facility may be set as the destination of a route search process. In addition, some recent navigation devices can also display detailed information, such as a name and a phone number, of the specific facility.

In the above-described known navigation devices, when the user wishes to contact the specific facility retrieved by a search process, he or she must input the phone number included in the information of the specific facility shown on a display of the navigation device to a mobile phone, such as a cellular phone, to make a phone call. Alternatively, if the user wishes to make a phone call from a position separated from the vehicle, he or she must write down the phone number of the specific facility shown on the display of the navigation device on a piece of paper or the like, or register the phone number in the mobile phone by using a registration function thereof. Accordingly, one must input the phone number shown on the display of the navigation device to the mobile phone or write it down on a piece of paper to make a phone call to the specific facility. In addition, because the user must perform such a cumbersome task while looking at the display of the navigation device, there is a possibility that the user will make a mistake in inputting or writing down the phone number, and call a wrong number.

### BRIEF SUMMARY

In view of the above-described situation, an object of the present invention is to provide a navigation device and a system and a method for transmitting facility information.

In order to attain the above-described object, a navigation device according to a preferred embodiment of the present invention includes a facility information storing unit that stores facility information for each of a plurality of facilities, the facility information including a phone number of the facility and a name for identifying the facility; a facility selecting unit that selects a facility satisfying a predetermined condition from among the plurality of facilities in accordance with an operation performed by a user; and a transmitting unit that transmits the facility information corresponding to the facility selected by the facility selecting unit to a mobile phone.

In addition, a facility information transmission method according to a preferred embodiment of the present invention uses the above-described navigation device and includes a first act in which the facility selecting unit selects the facility that satisfies the predetermined condition and a second act in which the transmitting unit transmits the facility information corresponding to the facility selected in the first act to the mobile phone.

When a specific facility is selected in accordance with the operation performed by the user, the phone number, etc., of the specific facility is transmitted to the mobile phone. Accordingly, it is not necessary for the user to operate the mobile phone to input the phone number, and the user can make a phone call to the specific facility without performing a cumbersome task. In addition, since it is not necessary for the user to manually input the phone number to register the phone number, wrong-number calls due to mistakes in inputting the phone number can be prevented.

In another preferred embodiment, the navigation device further includes a route searching unit that searches for a driving route connecting a predetermined starting point and a destination, and the facility selected by the facility selecting unit is set as the destination. In such a case, the user can make a phone call to the specific facility, which is set as the destination of a route search process, without performing a cumbersome task, and wrong-number calls can be prevented from occurring.

In yet another preferred embodiment, processes of searching for the driving route and a process of transmitting the facility information are performed in parallel by the route searching unit and the transmitting unit, respectively. In this case, when the route search process, which requires a relatively long time, is performed, the waiting time can be utilized effectively.

The predetermined condition used by the facility selecting unit for selecting the facility may be specified in accordance with the operation performed by the user. In this case, the user can make a phone call to the specific facility, which is searched for for a certain reason, without performing a cumbersome task, and wrong-number calls can be prevented from occurring.

The facility information for each facility may include classification information which indicates the kind of the facility. The transmitting unit may transmit the facility information including the classification information. In this case, the mobile phone that receives the facility information can register the phone number, etc., in correspondence with a group determined on the basis of the classification information. In addition, the phone number of the specific facility can be easily searched for when the user tries to make a phone call to the specific facility.

In another preferred embodiment, the navigation device further includes a confirming unit that displays the contents of the facility information to the user before the facility information is transmitted by the transmitting unit and confirms the contents of the facility information. In this case, unnecessary facility information can be prevented from being transmitted to the mobile phone due to operational mistakes. In addition, preferably, the confirming unit displays a confirmation window in which the contents of the facility information are shown and prompts the user to confirm the contents of the facility information. In this case, confirmation of the facility information can be easily and reliably performed on a display provided on the navigation device.

The navigation device may further include a map-image generating unit that generates a map image of an area around the facility selected by the facility selecting unit, and the transmitting unit may transmit the map image generated by the map-image generating unit to the mobile phone along with the facility information. Recent mobile phones generally have a function to display an image, so that the map image of the area around the specific facility can be displayed on such mobile phones. Accordingly, the user who has made or plans to make a phone call to the specific facility can go to the specific facility by using the map image displayed.

In addition, preferably, the map image generated by the map-image generating unit has a reduction scale which is set on the basis of the size and the resolution of a display provide on the movable phone. In this case, the mobile phone can receive a map image suitable for the display thereof.

The navigation device may further include a vehicle position detecting unit that detects a vehicle position, and the map image generated by the map-image generating unit may show both the vehicle position detected by the vehicle position detecting unit and the position of the facility selected by the facility selecting unit. Because both the vehicle position and the position of the specific facility are shown on the map image displayed, when the user walks from the vehicle to the specific facility, he or she can easily recognize the relative position between the vehicle and the specific facility, and walk along a suitable route.

The map image generated by the map-image generating unit may show a route that connects the vehicle position detected by the vehicle position detecting unit and the position of the facility selected by the facility selecting unit. Because the route is shown on the map image, the user can walk from the vehicle to the specific facility along an optimal route.

In addition, according to a preferred embodiment of the facility information transmission system, the facility information transmitted from the above-described navigation device is received by a mobile phone, and the mobile phone may receive the facility information transmitted by the transmitting unit and register the name and the phone number included in the facility information. Accordingly, the phone number and the name of the specific facility can be easily registered in the mobile phone having a registration function without performing a cumbersome task of manually inputting the phone number and the name.

In another embodiment of the facility information transmission system, the facility information transmitted from the above-described navigation device is received by the mobile phone, and the mobile phone has a function to receive the facility information and register the name and the phone number in correspondence with a group determined on the basis of the classification information. In recent mobile phones, phone numbers, etc., can be generally registered in groups set by the user. Accordingly, when such a mobile phone is used, not only the task of registering the phone number but that of setting the groups can be reduced.

In yet another embodiment of the facility information transmission system, the facility information transmitted from the above-described navigation system is received by the mobile phone, and the mobile phone has a function to receive the facility information and the map image transmitted by the transmitting unit and register the phone number and the name and a function to display the map image on the display. A mobile phone may be operable to register an image transmitted from another mobile phone, an image transmitted from a personal computer which is connected to the mobile phone via a predetermined interface, or a map image obtained from a map-distribution server if the mobile phone can be connected to a network. In any case, a map image of a specific area must be obtained by a certain method before it is registered in the mobile phone. However, according to a preferred embodiment of the present invention, the map image of the area around the specific facility is automatically generated and transmitted, and the mobile phone simply registers the received map image in correspondence with the phone number, etc., of the specific facility. Since the registration is also performed automatically, the cumbersome task of registering the phone number and the map image of the area around the specific facility can be greatly reduced.

As described above, it is not necessary for the user to operate the mobile phone to input the phone number, and the user can make a phone call to the specific facility without performing such a cumbersome task. In addition, since it is not necessary for the user to manually input the phone number, wrong-number calls due to mistakes in inputting the phone number can be prevented from occurring.

### BRIEF DESCRIPTION OF THE DRAWINGS

FIG. 1 is a diagram showing the construction of a navigation device according to an embodiment of the present invention;

FIG. 2 is a flowchart showing the operation performed by the navigation device in which facility information of a specific facility retrieved by a facility search process is transmitted to a cellular phone;

FIG. 3 is a diagram showing an example of a conformation message used for determining whether a command to perform registration to the cellular phone is issued;

FIG. 4 is a diagram showing an example of a completion message that is shown when a transmission process is completed; and

FIG. 5 is a flowchart showing the operation performed by the navigation device in which the facility information, etc., is transmitted to the cellular phone and a route search process is performed by setting the specific facility as the destination.

### DETAILED DESCRIPTION OF THE DRAWINGS AND PRESENTLY PREFERRED EMBODIMENTS

(1) Overall Construction of the Navigation Device

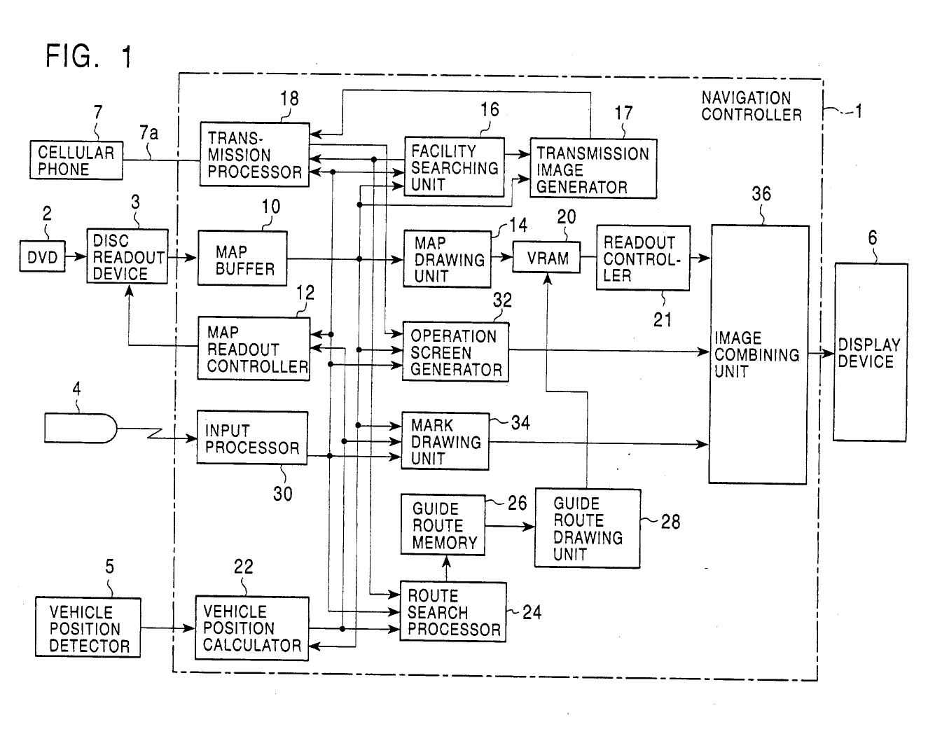

FIG. 1 is a diagram showing the construction of a navigation device according to an embodiment of the present invention. The navigation system shown in FIG. 1 includes a navigation controller 1, a DVD 2, a disk readout device 3, a remote control unit 4, a vehicle position detector 5, a display device 6, and a cellular phone 7.

The navigation controller 1 controls the overall operation of the navigation device. The navigation controller 1 executes predetermined operation programs by using a CPU, a ROM, a RAM, etc., and thereby serves its function. The detailed construction of the navigation controller 1 will be described below.

The DVD 2 is an information storage medium that stores map data that is necessary for displaying maps and searching for routes. More specifically, the DVD 2 stores the map data in units of rectangular map segments of a suitable size which are obtained by dividing a map with longitude and latitude lines. The map data corresponding to each of the map segments can be identified and read out by specifying a map segment number. In addition, the map data corresponding to each of the map segments includes (1) a “drawing unit” that includes various data necessary for displaying a map image, (2) a “road unit” that includes various data necessary for performing a map-matching process, searching for a route, and guiding a vehicle along the route, and (3) an “intersection unit” that includes various data corresponding to detailed information regarding intersections. The drawing unit also includes detailed facility data including names and phone numbers of facilities located in the area of the corresponding map segment and categories to which the facilities belongs.

The disc readout device 3 can receive one or more DVDs 2, and reads out the map data from one of the DVDs 2 under the control of the navigation controller 1. The discs inserted into the disc readout device 3 are not limited to DVDs, and CDs may also be used. Alternatively, the disc readout device 3 may also be constructed such that it can receive both DVDs and CDs selectively.

The remote control unit 4 includes a joystick used for inputting vertical and horizontal directions and various operation keys including numeric keys used for inputting numbers and a decision key used for confirming various settings, and outputs a signal corresponding to the operation performed by a user to the navigation controller 1.

The vehicle position detector 5 includes, for example, a global positioning system (GPS) receiver, a direction sensor, and a distance sensor. The vehicle position detector 5 detects a vehicle position (longitude and latitude) at a predetermined timing and outputs the detection result.

The display device 6 displays various images, such as a map image of the area around the vehicle position and a search result for facilities located around the vehicle position on the basis of drawing data output form the navigation controller 1.

The cellular phone 7 has a function to register facility information and images relating to the facility information in an internal memory thereof and a function to show the images registered in the internal memory on a display (if any is registered). Accordingly, the user can make a phone call to a phone number included in the facility information by using the cellular phone 7. Although the user can register the facility information by operating numeric keys, etc., provided on the cellular phone 7, the facility information may also be transmitted from the navigation device and be directly registered in the cellular phone 7. The cellular phone 7 is not necessarily continuously connected to the navigation controller 1 with a predetermined cable 7a, and is connected to the navigation controller 1 as necessary. Although a cellular phone is used as an example of a mobile phone in the present embodiment, other kinds of mobile phones such as a personal handyphone system (PHS) may also be used.

(2) Detailed Construction of the Navigation Controller 1

Next, the detailed construction of the navigation controller 1 will be described. The navigation controller 1 shown in FIG. 1 includes a map buffer 10, a map readout controller 12, a map drawing unit 14, a facility searching unit 16, a transmission image generator 17, a transmission processor 18, a VRAM 20, a readout controller 21, a vehicle position calculator 22, a route search processor 24, a guide route memory 26, a guide route drawing unit 28, an input processor 30, an operation screen generator 32, a mark drawing unit 34, and an image combining unit 36.

The map buffer 10 temporarily stores the map data read out from the DVD 2 by the disk readout device 3. The map readout controller 12 outputs a request to read out the map data corresponding to a predetermined area to the disk readout device 3 in accordance with the vehicle position calculated by the vehicle position calculator 22 and a command input from the input processor 30. Then, the map drawing unit 14 performs a drawing process necessary for displaying a map on the basis of the map data stored in the map buffer 10, and thereby generates map image data. The thus obtained map image data is stored in the VRAM 20, and the map image data corresponding to a single screen page is read out by the readout controller 21.

The facility searching unit 16 searches for a single, specific facility under a condition set in accordance with an operation performed by the user. Several methods may be used for searching for the specific facility: (1) a phone number may be input by the user and a facility corresponding to the facility information including the input phone number may be retrieved; (2) a facility name may be inputted by the user and a facility corresponding to the facility information including the input facility name may be retrieved; or (3) if facilities are classified into categories, a plurality of facilities that belong to a specified category may be retrieved and one of the retrieved facilities may be selected by the user. The facility searching unit 16 retrieves the facility information of the specific facility retrieved by the above-described search process from the map data stored in the map buffer 10, the facility information including the phone number, the name, and the category of the specific facility.

When a single facility is selected by the facility searching unit 16, the transmission image generator 17 generates a map image of the area around this facility. The map image is generated by reading out the data of the drawing unit corresponding to an area centered on the coordinates (longitude and latitude) of the selected facility from the map buffer 10. In addition, the map image is generated at a suitable reduction scale by taking the display size, the resolution, etc., of the display of the cellular phone 7.

The transmission processor 18 transmits the facility information corresponding to the facility selected by the facility searching unit 16 and the map image data of the area around the specific facility generated by the transmission image generator 17 to the cellular phone 7 which is connected to the transmission processor 18 with the cable 7a.

The vehicle position calculator 22 calculates the vehicle position on the basis of the detection data output from the vehicle position detector 5. In addition, when the calculated vehicle position is not on any road included in the map data, the vehicle position calculator 22 performs a map-matching process for correcting the vehicle position.

The route search processor 24 searches for a driving route (guide route) that connects a starting point and a destination (or an intermediate point) which are specified by the user under predetermined conditions. When the specific facility is searched for and retrieved by the facility searching unit 16, the specific facility retrieved by the search process may also be set as the destination.

The guide route memory 26 stores route data that corresponds to the driving route determined by the search process performed by the route search processor 24. The guide route drawing unit 28 selects a portion of the route data stored in the guide route memory 26 included in the area corresponding to the map image stored in the VRAM 20 at the time, and generates guide route drawing data used for superimposing the guide route on the map.

The input processor 30 outputs signals corresponding to commands for various operations input from the remote control unit 4 to each part of the navigation controller 1. The operation screen generator 32 generates drawing data necessary for displaying an operation screen used by the user to input commands for various operations. The mark drawing unit 34 generates drawing data necessary for displaying various marks including a vehicle position mark displayed at a position corresponding to the vehicle position after the map matching process is performed, a cursor mark displayed at a position corresponding to a cursor position, etc.

The image combining unit 36 combines the map image data corresponding to a single screen page read out from the VRAM 20 by the readout controller 21 and the drawing data output from the operation screen generator 32 and the mark drawing unit 34, and outputs the combined drawing data to the display device 6.

The map buffer 10 corresponds to a facility information storing unit, the facility searching unit 16 to a facility selecting unit, the transmission processor 18 to a transmitting unit, the route search processor 24 to a route searching unit, the transmission image generator 17 to a map-image generating unit, and the vehicle position calculator 22 to a vehicle position detecting unit.

(3) Operation of the Navigation Device

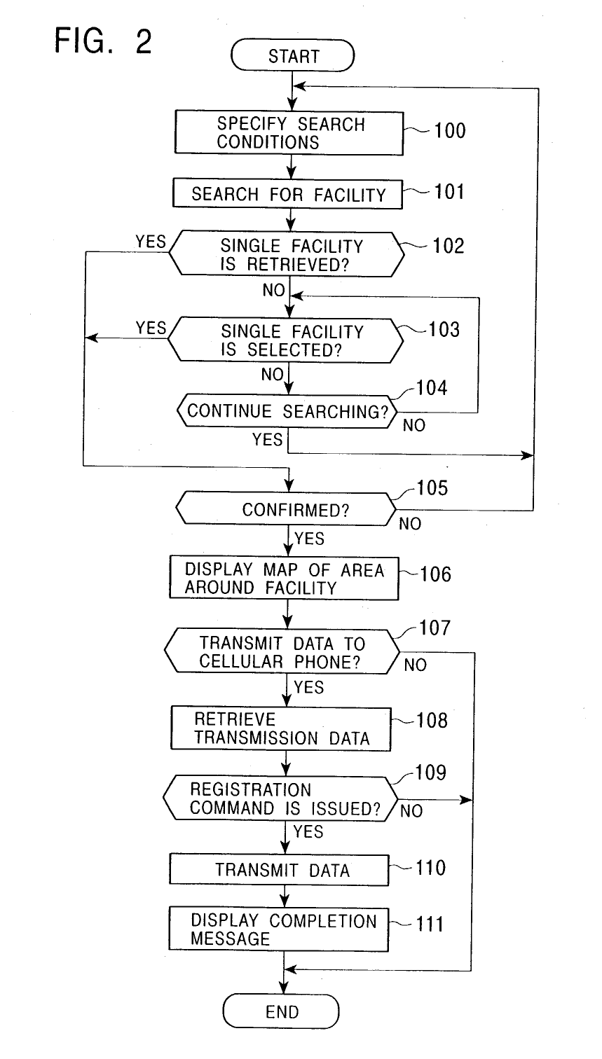

FIG. 2 is a flowchart showing the operation performed by the navigation device in which facility information, etc., relating to a specific facility retrieved by a facility search process is transmitted to the cellular phone. The operation shown in FIG. 2 starts, for example, when the user inputs a command to search for a specific facility and ends when a phone number, etc., of the facility retrieved by the search process is transmitted to the cellular phone 7.

When the user operates the remote control unit 4 and inputs a certain search condition (Act 100), the facility searching unit 16 searches for a facility which satisfies the search condition (Act 101) and determines whether or not a single facility is retrieved as a search result (Act 102). If a plurality of facilities are retrieved, the result of the determination is negative, and the facility searching unit 16 determines whether a single facility is selected from among the plurality of facilities retrieved (Act 103). If the user does not select a facility from among the facilities retrieved, that is, when the result of the determination is negative, it is determined whether the search process is to be continued (Act 104). If a command to continue the search process is issued by the user, the result of the determination is affirmative, and the operation returns to Act 100 to continue the search from among the facilities which are already retrieved by using a new search condition. If the command to continue the search is not issued, the result of the determination in Act 104 is negative, and the operation returns to Act 103, where the determination of whether a single facility is selected is repeated.

In addition, when a single facility is retrieved by the search process and the result of the determination in Act 102 is affirmative, or when a single facility is selected from among a plurality of facilities retrieved by the search process and the result of the determination in Act 103 is affirmative, the facility searching unit 16 determines whether to decide that the retrieved facility is the final search result (Act 105). If the user pushes a decision key provided on the remote control unit 4, the result of the determination is affirmative, and the map image of the area around this specific facility is shown on the display device 6 (Act 106). For example, when the position of this facility is transmitted from the facility searching unit 16 to the map readout controller 12, the map data is read out from the DVD 2 under the control of the map readout controller 12, and is stored in the map buffer 10. Then, the map image of the area around the specific facility is generated by the map drawing unit 14 on the basis of the map data stored in the map buffer 10, and the map image is displayed. If a cancel key for cancelling the process is pushed instead of the decision key of the remote control unit 4 after a single facility is retrieved, the result of the determination in Act 105 is negative, and the operation returns to Act 100 to perform the search process under a new search condition.

When the map image of the area around the specific facility is shown on the display, the transmission processor 18 determines whether to transmit the phone number, etc., of the specific facility to the cellular phone 7 (Act 107). For example, when the transmission is set to be performed on a setting screen, when the user selects to perform the transmission on a confirmation screen inquiring whether or not to perform the transmission, or when the cellular phone 7 is connected to the navigation device while it is set such that the transmission is automatically performed as long as the cellular phone 7 is connected to the navigation device, the result of the determination in Act 107 is affirmative. Next, the transmission processor 18 retrieves transmission data (Act 108), displays the contents of the retrieved transmission data to the user, and determines whether a command to register the displayed contents in the cellular phone 7 is issued (Act 109). The transmission data includes the name and the phone number of the specific facility retrieved by the facility searching unit 16, the category, that is, classification information used as group information when the registration to the cellular phone 7 is performed, and the map image of the area around the specific facility generated by the transmission image generator 17. In addition, the name, the phone number, and the category of the specific facility included in the transmission data are shown in a confirmation window displayed to determine whether a command to register the data is issued.

When a command to perform the registration to the cellular phone 7 is issued, the result of the determination in Act 109 is affirmative, and the transmission processor 18 transmits the transmission data including the name and the phone number of the specific facility and the map image of the area around the specific facility to the cellular phone 7 via the cable 7a (Act 110). Then, a predetermined completion message is shown on the display device 6 when the transmission process is completed (Act 111).

FIG. 3 is a diagram showing an example of a confirmation message used for determining whether a command to perform the registration to the cellular phone 7 is issued. In the confirmation window shown in FIG. 3, the name (XX dental clinic), the phone number (03-XXXX-XXXX), and the category (group name: hospital) of a specific facility and a message “register?” are displayed.

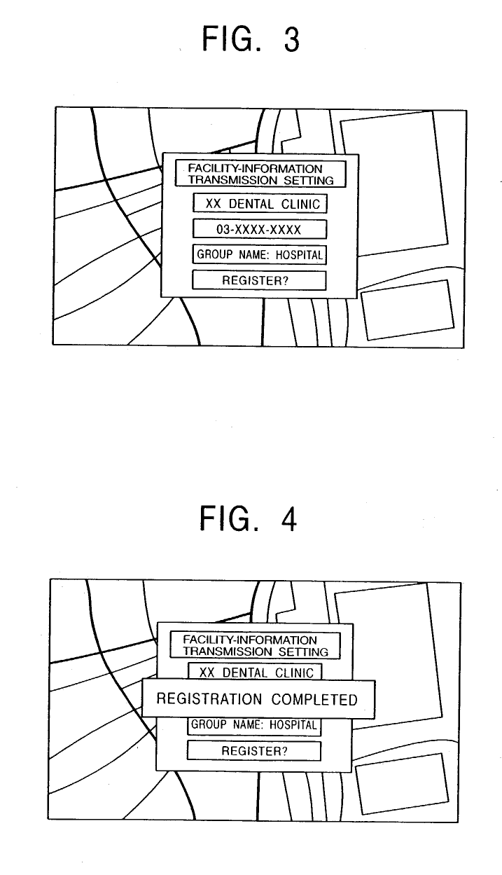

FIG. 4 is a diagram showing an example of a completion message which is shown when the transmission process is completed. As show in FIG. 4, when the data transmission process performed in Act 110 of FIG. 2 is completed, the completion message “registration completed” is superimposed on the confirmation message shown in FIG. 3.

In a preferred embodiment of the navigation device, when a specific facility is retrieved on the basis of a search condition specified by the user, the phone number, etc., of the specific facility is transmitted to the cellular phone 7. Accordingly, it is not necessary for the user to operate the cellular phone 7 to input the phone number, and the user can make a phone call to the specific facility without performing a cumbersome task. In addition, since it is not necessary for the user to manually input the phone number for registering the phone number, wrong-number calls due to mistakes in inputting the phone number can be prevented from occurring.

In addition, the data transmitted to the cellular phone 7 from the navigation device includes the category of the specific facility that serves as the classification information. Accordingly, the cellular phone 7, which receives the transmission date, can register the name, the phone number, etc., of the specific facility in correspondence with a group determined on the basis of the category. Accordingly, when the user tries to make a phone call to the specific facility with the cellular phone 7, the phone number can be easily searched for by specifying the group name corresponding to the category of the specific facility.

In addition, the data transmitted to the cellular phone 7 from the navigation device also includes the map image of the area around the specific facility. Accordingly, when the map image is displayed on the cellular phone 7 having an image-display function, the user who has made or plans to make a phone call to the specific facility can go to the specific facility without getting lost by using the map image displayed.

The present invention is not limited to the above-described embodiment, and various modifications are possible within the scope of the present invention. For example, in the above-described embodiment, the specific facility is retrieved by the facility searching unit 16, and the phone number, etc., thereof is registered in the cellular phone 7. However, the specific facility retrieved by the search process is not restricted to only be registered in the cellular phone 7, but rather can also be set as the destination of a route search process.

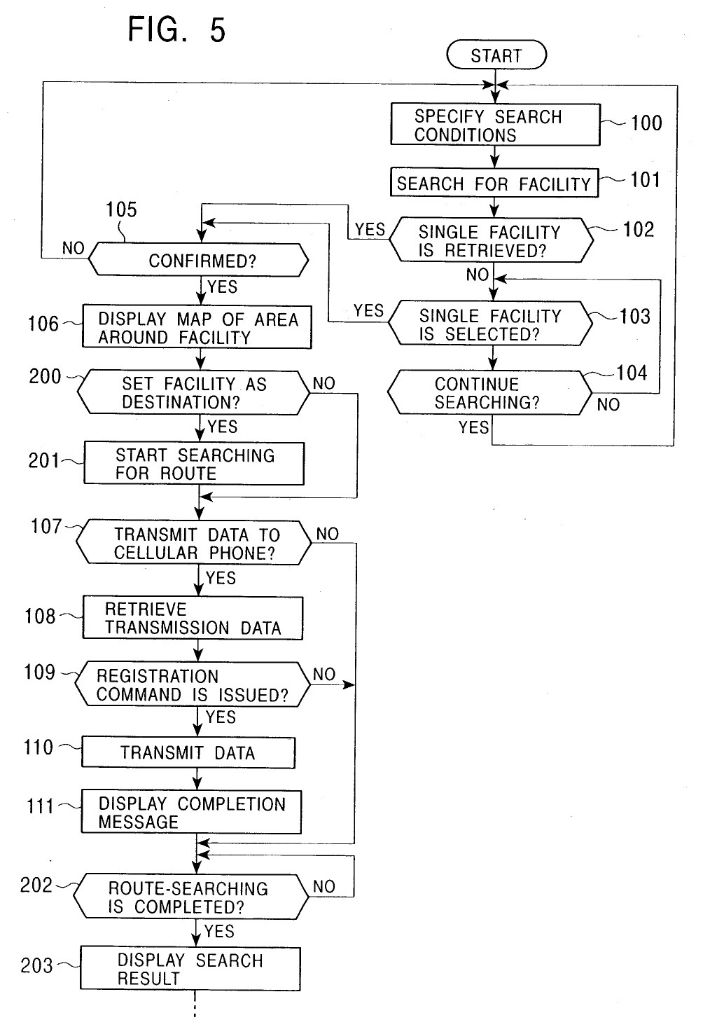

FIG. 5 is a flowchart showing the operation performed by the navigation device in which the facility information of the specific facility retrieved by the facility search process is transmitted to the cellular phone and a route search process is performed by setting the specific facility as the destination. The flowchart shown in FIG. 5 is similar to that shown in FIG. 2 except that Acts 200 to 203 are added, and these acts will be described below.

After the map image of the area around the specific facility retrieved by the facility search process is displayed (Act 106), the route search processor 24 determines whether to set the specific facility as the destination of the route search process (Act 200). If a command to set the specific facility as the destination is issued by the user, the result of the determination is affirmative, and the route search processor 24 starts the route search process by using the current vehicle position calculated by the vehicle position calculator 22 as the starting point and the specific facility as the destination (Act 201). Then, it is determined whether to transmit the phone number, etc., of the specific facility to the cellular phone 7 (Act 107). When the command to set the specific facility as the destination is not issued by the user, the result of the determination in Act 200 is negative, and the step of determining whether to transmit the phone number, etc., of the specific facility to the cellular phone 7 (Act 107) is immediately performed.

Then, when the phone number, etc., is transmitted to the cellular phone 7 (Act 110) and the completion message is displayed (Act 111), the route search processor 24 determines whether the route search process is completed (Act 202). If the route search process is not completed, the result of the determination is negative, and this determination is repeated. If the route search process is completed, the result of the determination in Act 202 is affirmative, and the guide route drawing unit 28 superimposes the driving route, that is, the search result obtained by the route search process and stored in the guide route memory 26, on the map image (Act 203). Then, processes such as an intersection guiding process are performed for guiding the vehicle along the route.

Accordingly, when the route search process is performed by setting the specific facility retrieved by the search process as the destination, the process of transmitting the phone number, etc., of the specific facility can be performed in parallel to the route search process. Therefore, when the route search process, which requires a relatively long time, is performed, the waiting time can be utilized effectively.

In addition, in the above-described embodiment, the cellular phone 7 registers the phone number, etc., in correspondence with a group determined on the basis of the category included in the facility information which is transmitted from the navigation device. Alternatively, however, a group in which the phone number, the name, etc., are to be registered may be selected by the user from among groups which are set in the cellular phone 7 in advance or be created when the registration is performed.

In addition, in the operation shown in FIG. 5, the process of transmitting the facility information and the map image and the route search process are performed in parallel. However, at least the map image may be transmitted when the user gets out of the vehicle at a location close to the destination after driving along the route obtained by the route search process. Preferably, the map image including both the current vehicle position calculated by the vehicle position calculator 22 and the position of the specific facility which is set as the destination is transmitted to the cellular phone 7. More preferably, the map image also includes a route connecting the current vehicle position and the position of the specific facility. In such a case, the user can walk from the vehicle to the specific facility along an optimal route by using the map image.

It is to be understood that a wide range of changes and modifications to the embodiments described above will be apparent to those skilled in the art and are contemplated. It is therefore intended that the foregoing detailed description be regarded as illustrative, rather than limiting, and that it be understood that it is the following claims, including all equivalents, that are intended to define the spirit and scope of the invention.

I claim:

1. A navigation device comprising:
a facility information storing unit operable to store facility information for each of a plurality of facilities, the facility information including a phone number of the facility and a name for identifying the facility;
a facility selecting unit operable to select a facility that satisfies a predetermined condition from among the plurality of facilities in accordance with an operation performed by a user; and
a transmitting unit operable to transmit the facility information corresponding to the facility selected by the facility selecting unit to a mobile phone.

2. The navigation device of claim 1, further comprising a route searching unit operable to search for a driving route that connects a predetermined starting point and a destination,
wherein the facility selected by the facility selecting unit is set as the destination.

3. The navigation device of claim 2, wherein a process of searching for the driving route and a process of transmitting the facility information are performed in parallel by the route searching unit and the transmitting unit, respectively.

4. The navigation device of claim 1, wherein the predetermined condition used by the facility selecting unit for selecting the facility is specified in accordance with the operation performed by the user.

5. The navigation device of claim 1, wherein the facility information for each facility further includes classification information that indicates the kind of the facility, and
wherein the transmitting unit transmits the facility information including the classification information.

6. The navigation device of claim 1, further comprising a confirming unit operable to display the contents of the facility information to the user before the facility information is transmitted by the transmitting unit and confirms the contents of the facility information.

7. The navigation device of claim 6, wherein the confirming unit displays a confirmation window in which the contents of the facility information are displayed and prompts the user to confirm the contents of the facility information.

8. The navigation device of claim 1, further comprising a map-image generating unit operable to generate a map image of an area around the facility selected by the facility selecting unit,
wherein the transmitting unit transmits the map image generated by the map-image generating unit to the mobile phone along with the facility information.

9. The navigation device of claim 8, wherein the map image generated by the map-image generating unit has a reduction scale that is set on the basis of the size and the resolution of a display provide on the mobile phone.

10. The navigation device of claim 8, further comprising a vehicle position detecting unit operable to detect a vehicle position,
wherein the map image generated by the map-image generating unit shows both the vehicle position detected by the vehicle position detecting unit and the position of the facility selected by the facility selecting unit.

11. The navigation device of claim 10, wherein the map image generated by the map-image generating unit further shows a route which connects the vehicle position detected by the vehicle position detecting unit and the position of the facility selected by the facility selecting unit.

12. A facility information transmission system comprising:
a navigation device including a facility information storing unit operable to store facility information for each of a plurality of facilities, the facility information including a phone number of the facility and a name for identifying the facility, a facility selecting unit operable to select a facility that satisfies a predetermined condition from among the plurality of facilities in accordance with an operation performed by a user, and a transmitting unit operable to transmit the facility information corresponding to the facility selected by the facility selecting unit to a mobile phone, the facility information transmitted from the navigation device being received by the mobile phone,
wherein the mobile phone has a function to receive the facility information transmitted by the transmitting unit and register the name and the phone number included in the facility information.

13. The facility information transmission system of claim 12, wherein the facility information for each facility further includes classification information which indicates the kind of the facility, and
wherein the transmitting unit transmits the facility information including the classification information.

14. The facility information transmission system of claim 12, wherein the facility information for each facility further includes classification information which indicates the kind of the facility, and
wherein the mobile phone has a function to receive the facility information including the classification information and register the name and the phone number in correspondence with a group determined on the basis of the classification information.

15. The facility information transmission system of claim 12, further comprising a map-image generating unit operable to generate a map image of an area around the facility selected by the facility selecting unit,
wherein the transmitting unit transmits the map image generated by the map-image generating unit to the mobile phone along with the facility information.

16. A facility information transmission method comprising the acts of:
providing a navigation device including a facility information storing unit operable to store facility information for each of a plurality of facilities, the facility information including a phone number of the facility and a name for identifying the facility;
providing a mobile phone operable to receive facility information from the navigation device;
selecting a facility that satisfies a predetermined condition; and
transmitting facility information corresponding to the facility selected to the mobile phone.

17. The facility information transmission method of claim 16 further comprising the act of searching for a driving route with the facility selected set as the destination.

18. The facility information transmission method of claim 16, further comprising the act of transmitting classification information to the mobile phone.

19. The facility information transmission method of claim 16, further comprising the act of displaying the contents of the facility information to the user before the facility information is transmitted

20. The facility information transmission method of claim 16, further comprising the act of confirming the contents of the facility information before the facility information is transmitted to the mobile telephone.

21. The facility information transmission method of claim 16 further comprising the act of generating a map image of an area around the selected facility.

22. The facility information transmission method of claim 21, further comprising the act of transmitting the generated map image to the mobile phone.

23. The facility information transmission method of claim 16, wherein the predetermined condition is entered into the navigation device by a user.
